(19) United States
(12) Patent Application Publication
(10) Pub. No.: US 2017/0220936 A1
(43) Pub. Date: Aug. 3, 2017

(54) Identifying Linguistically Related Content for Corpus Expansion Management

(71) Applicant: International Business Machines Corporation, Armonk, NY (US)

(72) Inventors: Daniel F. Gruhl, San Jose, CA (US); Joseph M. Kaufmann, Austin, TX (US); Joseph N. Kozhaya, Morrisville, NC (US); Pablo N. Mendes, San Jose, CA (US); Sridhar Sudarsan, Round Rock, TX (US)

(73) Assignee: International Business Machines Corporation, Armonk, NY (US)

(21) Appl. No.: 15/010,366

(22) Filed: Jan. 29, 2016

(51) Int. Cl. G06N 5/04; G06N 99/00

(52) U.S. Cl. CPC G06N 5/04; G06N 99/005

(57) ABSTRACT

Embodiments of the invention relate to identification of material that contains linguistically related content. Key phrases are filtered through a content store to ascertain the linguistically related content and to move the identified content to a target corpus. At least two iterations of the filtering process are employed. Each subsequent iteration of the filtering process identifies at least one new key phrase within the filtered material. In addition, each subsequent iteration takes place with a union of each previously employed key phrase and each new key phrase. As new content is identified, the content is populated to the target corpus.

### BACKGROUND

The present invention relates to identifying components from a large body of content that is related to specific content. More specifically, the embodiment(s) relates to identifying linguistically relevant content.

The aspect of collaboration entails cooperation among a plurality of individuals or components. Collaboration may include combining or otherwise gathering data from the collaborative partners. One by-product of collaboration is the abundance of information. Correlated to collaboration is the challenge of identification of useful content from the gathered data. Specifically, the challenge relates to sifting through an abundance of data to ascertain that data which is useful or otherwise relevant to the task at hand.

### SUMMARY

The embodiments include a method, computer program product, and system for identification of linguistically related material in a computing environment.

The method, computer program product, and system pertain to linguistically related content, and more specifically to identification of the content. A target corpus is initialized to receive content, and a domain corpus is provided in communication with the target corpus. At least one initial key phrase is extracted from the domain corpus. The extracted key phrase(s) is stored in a master list at a first memory location. A user interface is employed to facilitate a structured process for populating the target corpus with linguistically related documents. More specifically, the user interface is employed as a platform to: review the key phrase(s), select one or more documents from a source corpus for potential inclusion in the target corpus, filter a list of the selected documents, populate the target corpus with one or more documents from the filter list, and examine the target corpus. The act of populating the target corpus may take place in multiple iterations of key phrase review and document filtering. As new documents are identified for inclusion in the target corpus, new key phrases associated with the new documents are added to the master list. Extraction of a second set of related documents for populating to the target corpus entails the use of a union of new key phrases and prior key phrases as a filter.

These and other features and advantages will become apparent from the following detailed description of the presently preferred embodiment(s), taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments and not of all embodiments unless otherwise explicitly indicated.

FIG. 1 depicts a block diagram illustrating different collections and their relationships.

FIG. 2 depicts a flow chart illustrating a process for demonstrating the relationship among the corpora, and leveraging the relationship to identify linguistically related content.

FIG. 3 depicts a flow chart illustrating a process for the augmenting the target corpus with a second set of related documents.

FIG. 4 depicts a block diagram illustrating a computing environment to incorporate and use one or more aspects, in accordance with an embodiment.

FIG. 5 depicts a block diagram illustrating a user interface with a plurality of fields in support of populating and augmenting the target corpus.

FIG. 6 depicts a block diagram illustrating hardware components of a computer system for implementing an embodiment.

FIG. 7 depicts a schematic example of a cloud computing node.

FIG. 8 depicts a block diagram illustrative of a cloud computing environment.

FIG. 9 depicts a block diagram illustrating of a set of functional abstraction layers provided by the cloud computing environment shown in FIG. 7.

### DETAILED DESCRIPTION

It will be readily understood that the components of the present embodiment(s), as generally described and illustrated in the Figures herein, may be arranged and designed in a wide variety of different configurations. Thus, the following detailed description of the embodiments of the apparatus, system, and method of the present embodiment(s), as presented in the Figures, is not intended to limit the scope of the embodiment(s), as claimed, but is merely representative of selected embodiments.

Reference throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiment(s) as claimed herein.

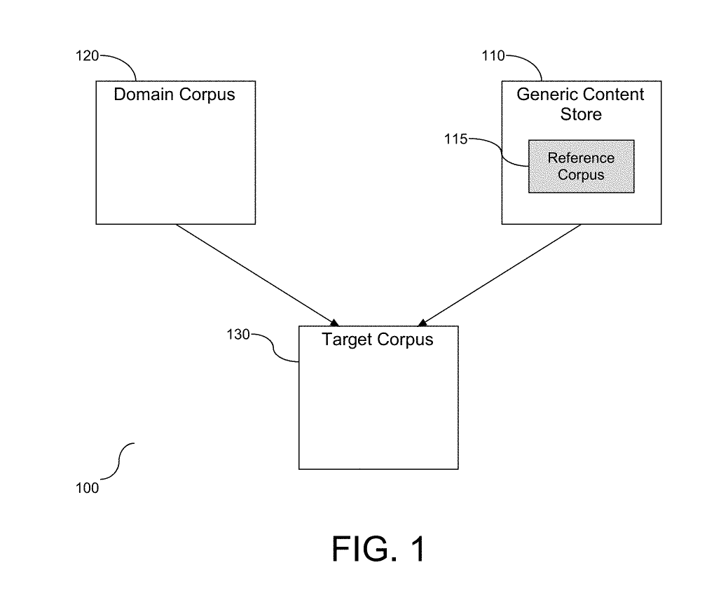

A corpus is understood as a large or complete collection of materials. There are different categories of corpora, including a domain corpus and a reference corpus. The domain corpus is a collection of material that has an initial relationship. The reference corpus functions as a filtered category of material from a generic content store. For example, the reference corpus may be in the form of a subset of the generic content storage. In one embodiment, the reference corpus may be different from the generic content storage, and in another embodiment, the reference corpus overlaps the generic store. Referring to FIG. 1, a block diagram (100) is provided illustrating the different collections and their relationships. As shown, a generic content store (110) is provided with a reference corpus (115) demonstrating a corpus of materials that are filtered from the content store (110). In addition, the domain corpus (120) is shown as a separate and distinct corpus from the reference corpus (115) and the content store (110). The domain corpus (120) represents a collection of materials specific to a domain of interest. Examples of such domains include, but are not limited to finance, education, and healthcare. A target corpus (130) is shown herein as separate and distinct from the reference corpus (115), the content store (110), and the domain corpus (120). The target corpus (130) represents a set of materials that are linguistically related to the filtered material of the reference corpus (115) and the domain corpus (120). More specifically, the target corpus (130) is configured and formatted to receive materials from the reference corpus (115) that contain language that is related to material identified in the domain corpus (120). Accordingly, the target corpus (130) is separately related to both the reference corpus (115) and the domain corpus (120).

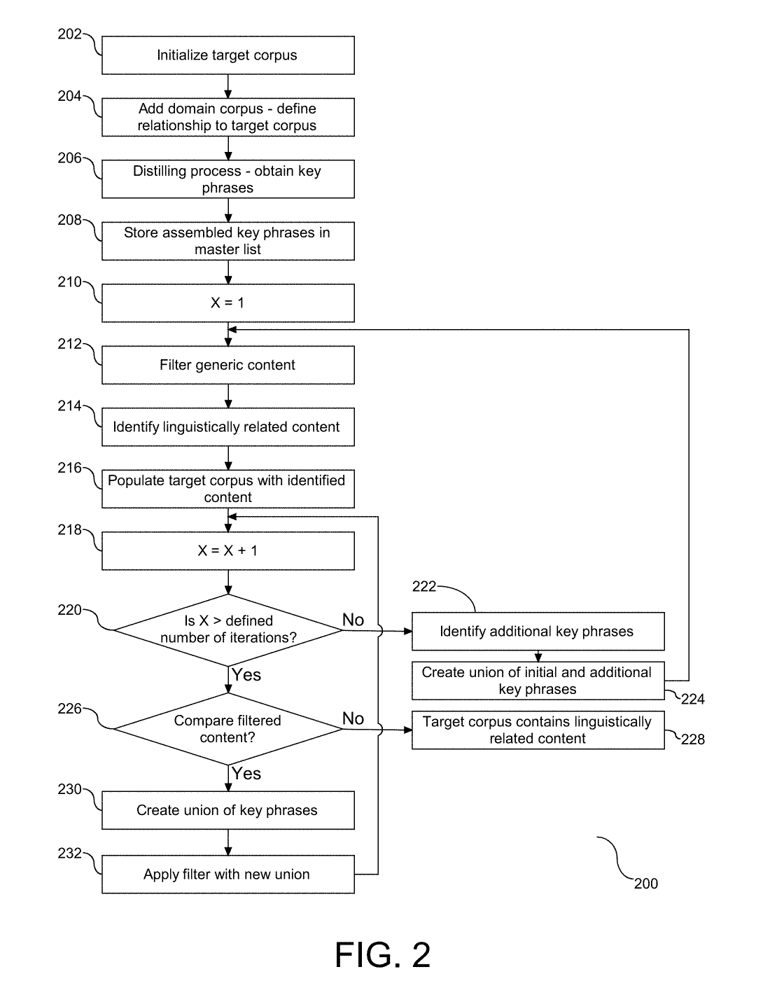

As shown in FIG. 1, several corpora are separately disclosed and defined. Referring to FIG. 2, a flow chart (200) is provided to demonstrate the relationship among the corpora, and leveraging the relationship to identify linguistically related content. In FIG. 1, the target corpus is defined as a set of filtered materials. Prior to populating any materials, the target corpus is initialized (202), e.g. in an initial state the target corpus is an empty set. In one embodiment, the target corpus may be initialized with additional criteria at step (202), including but not limited to, designating the characteristics associated with a full or complete target corpus. For example, in one embodiment, the process of identifying linguistically related content has a minimum of two iterations. A minimum number of iterations may be defined, or in one embodiment, a maximum number of iterations. In addition to or separate from the quantity of iterations, the maximum size of the target corpus may also be defined. As described in detail below, the target corpus is subject to being populated. Accordingly, as part of or subsequent to the target corpus initialization at step (202), the criteria for stopping the iterations with respect to one or more characteristics of the target corpus may be defined and assigned.

Once the initialization at step (202) is completed, the domain corpus (120) is added (204). More specifically, at step (204), the relationship between the domain corpus (120) and the target corpus (130) is defined. As shown and described in FIG. 1, the domain corpus includes and represents a collection of materials. Following step (204), a distilling process takes place with respect to the domain corpus to obtain one or more key phrases, e.g. phrases that have a high affinity to the domain corpus, and specifically, one or more key phrases that are unique to the materials within the domain corpus (206). In one embodiment, the reference corpus (115) obtained from an input set of reference corpus is used to detect domain specific key phrases in the domain corpus (120). For example, in one embodiment, the reference corpus identifies one or more key phrases that occur with a higher statistical likelihood in the domain corpus. The identified key phrases are saved in a master list of key phrases (208), which would be updated in subsequent iterations for identifying relevant documents for expanding the target corpus.

Following identification of at least one key phrase, the process of identifying linguistically related materials begins. More specifically, the identification process pertains to identifying a subset of content that is most related to the identified key phrase(s). In one embodiment, there is a minimum of two iterations associated with the process. As such, an iteration counting variable, X, is initialized (210). Following step (210), the generic content is filtered with the identified key phrase(s) (212). Output from the filtering at step (212) identifies content from a source corpus that is linguistically related to at least one of the key phrases (214). In the event there is more than one key phrase employed in the filtering process, the filtering includes a union of all of the identified key phrases at the same time. In one embodiment, the content store (110) is classified by categories, and the filtering at step (212) searches the most common category for the identified union of key phrases. In one embodiment, the filtering at step (212) extracts documents from an indexed version of the content store based on the union of identified key phrases. For example, in one embodiment, the indexed version of the content accommodates a ceiling with respect to a maximum quantity of extracted content with respect to the index.

Content identified at step (214) as being linguistically related to the union of key phrases is populated to the target corpus (214). In the case of the first iteration, the identified content populates the empty target corpus. During subsequent iterations, the population of content is limited to new content, thereby reducing duplication of content in the target corpus. As shown, after the target corpus is populated with content at step (216), the iteration counting variable is incremented (218), and it is determined if the value of the variable is greater than a defined number of iterations (220). A negative response to the determination at step (220) is followed by identifying one or more additional key phrases for a subsequent iteration with the content store (222). Different processes may be employed for identification of additional key phrases. For example, the documents added to the target corpus may be ranked or otherwise sorted, and a group of documents with a higher ranking may be subject to a distilling process, as shown and described at step (206) to identify additional key phrases.

The goal of the second or additional iteration is to identify additional content that is linguistically related to the domain corpus. Following the identification of additional key phrases at step (222) a union of the initial key phrases with the identified additional key phrase(s) takes place (224), followed by a return to step (212) for additional filtering. In one embodiment, the second or subsequent iteration requires criteria that are in addition to the prior iteration.

An Affirmative response to the determination at step (220) is followed by a comparison of the content found during the initial filtering process and each of the subsequent filtering processes (226), and more specifically, if the subsequent filtering steps has yielded additional content. A non-affirmative response to the comparison at step (226) is an indication that the iterative process has concluded and that the content in the target corpus is the linguistically related content (228). In one embodiment, the process at step (228) augments any new filtered content to the target corpus. Various factors may be associated with the conclusion. For example, in one embodiment, the process may reach a conclusion because new key phrases were not identified. Other factors may also be employed for concluding the iterative searching process, including but not limited to criteria of the size of the target corpus being met, and no new content identified during a subsequent iteration. Accordingly, as demonstrated the process of populating the target corpus concludes when either the number of iterations of key phrase identification and document filtering has been attained, or the filtering process does not yield any new documents.

Following an affirmative response to step (226), a new union of key phrases is created (230), with the union including the previously applied key phrases and any new key phrases found in the recently augmented content. A subsequent filtering of the content store takes place with the limitations of the new union of key phrases (232). The process then returns to step (218). Accordingly, any materials identified in the subsequent iteration include the new union of key phrases.

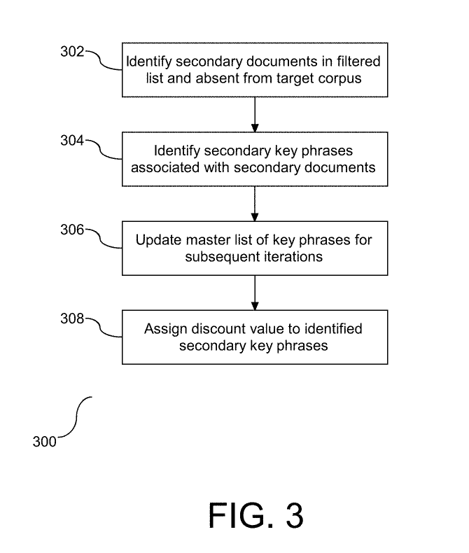

The process shown and described in FIG. 2 relates to an initial population of the target corpus. Referring to FIG. 3, a flow chart (300) is provided illustrating a process for the augmenting the target corpus with a second set of related documents. As shown, one or more secondary documents in the filtered list of FIG. 2 and absent from the target corpus are identified (302). In addition, key phrases associated with these secondary documents are identified (304). Based upon the identifications at step (302) and (304), the master list of key phrases is updated for subsequent iterations (306). This master list update includes assigning a discount value to the identified secondary key phrases (308) from step (304). The process outlined herein supports populating the target corpus with a second set of related documents that are linguistically related to the documents already populating the target corpus. In addition, the discount value enables the documents to be ranked or otherwise ordered to address a hierarchy of strength of documents in the target corpus. In one embodiment, a document in the target corpus that was identified with a secondary key phrase may have a lower ranked value, indicating that the document may have a weaker linguistic relationship to documents in the target corpus when compared to a document identified with a primary key phrase in the initial target corpus population process.

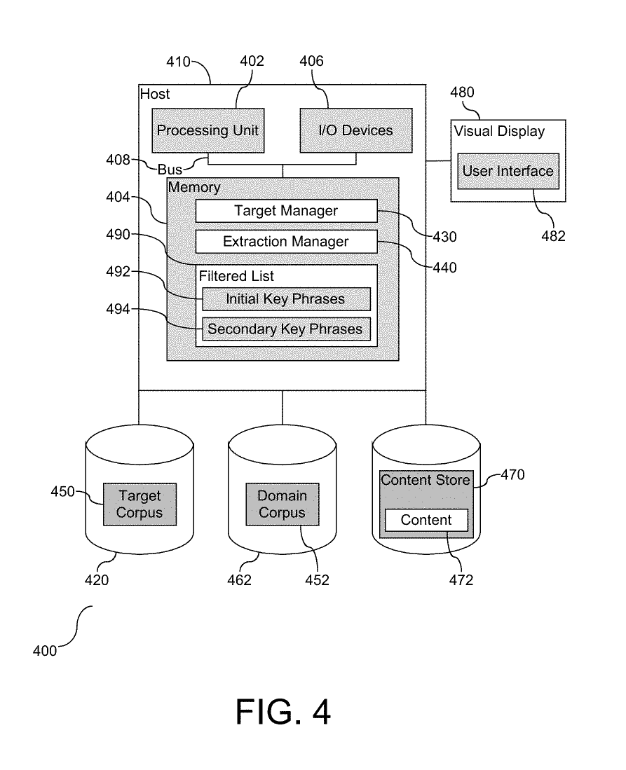

The process shown and described in FIGS. 2 and 3 systematically expands the content of the target corpus to include material and content that is linguistically related to the domain corpus. Referring to FIG. 4, a block diagram (400) is provided illustrating a computing environment to incorporate and use one or more aspects, in accordance with an embodiment. The computing environment includes a host (410) with a processor (402) (e.g. a central processing unit), memory (404) (e.g. main memory), and one or more input/output (I/O) devices and/or interfaces (406) coupled to one another via, for example, one or more buses (408) and/or other connections. The central processing unit (402) executes instructions and code that are stored in memory (404). This code enables the processing environment to identify linguistically related content. As shown and described in FIGS. 1 and 2, the code is configured to identify and correlate content, with the content stored in one or more persistent storage devices. Persistent storage (420) is shown local to and in communication with the processor (402). In one embodiment, the persistent storage may be remote from the processor (402). Similarly, in one embodiment, the code to support the content identification may be accessed across a network connection to shared resources, e.g. a cloud computing environment.

As shown herein, the system employs at least two tools to support the content identification, including a target manager (430) and an extraction manager (440). The managers (430) and (440) are shown embedded in the system memory (404) and in communication with the processor (402). In one embodiment, the functionality of the managers (430) and (440) is embedded in an application in communication with the processor (402). The target manager (430) functions to initialize a target corpus (450), so that the target corpus (450) can receive content, specifically content that is deemed to be linguistically related. In the example shown herein, the target corpus (450) is local to the system and embedded in the persistent storage (420). However, in one embodiment, the target corpus (450) may be located on a remote site in communication with the processor (402) across a network connection. The extraction manager (440) is shown herein in communication with the target manager (430). In one embodiment, the managers (430) and (440) may be located on different sites or resource locations. The extraction manager (440) functions to extract an initial key phrase from a domain corpus (452). As shown, the domain corpus (452) is stored at a first memory location (462). In one embodiment, the memory location (462) of the domain corpus (452) may be remote from the processor (402). The extraction manager (440) applies the key phrase, also referred to herein as the initial key phrase, to the content store (470) to extract related material from the store. More specifically, the extraction includes material that is linguistically related to the initial key phrase(s). Content (472) in the store (470) that is determined to be linguistically related to the key phrase(s) is stored in the target corpus (450). In one embodiment, the extraction manager copies the content from the store (470) to the target corpus (450). The initial iteration of the extraction manager populates the target corpus (450) with content (472) from the store (470) determined to be linguistically related to the initial key phrase(s).

As described above with respect to FIGS. 2 and 3, the target corpus can be expanded with additional content following the initial iteration. More specifically, the extraction manager (440) assesses the subset of content (472) for one or more additional key phrases. The subset of content (472) was initially identified with the initial set of key phrases. The extraction manager (440) forms a union of all the identified key phrases, including the initial key phrases and the additional key phrases, and applies the union to the content store (470). Content that is returned from the application of the union of key phrases is selectively added to the target corpus (450). More specifically, the added content is content that is distinct from the subset of content (472) added to the target corpus (450) in the first iteration. In one embodiment, the target manager (430) identifies criteria for the target corpus (450), and the iterative process of identifying linguistically related material will conclude when the criteria for the target corpus (450) has been attained. The aspect of expanding the target corpus (450) through iterative searches may be automated or non-automated. For example, in one embodiment, the expansion process may cease once the identified key phrases are the same as the key phrases in the prior union of key phrases, in other words the union of key phrases does not add any new key phrases. Similarly, in one embodiment, the expansion process ends when application of the key phrases may not yield new content. Similarly, in one embodiment, the expansion process may cease when the target corpus (450) has reached capacity. Accordingly, various criteria and combinations of criteria may be applied to ascertain convergence of the iterative processing.

As further shown herein, a visual display (482) is provided in communication with the host (410). The visual display (480) enables presentation of a user interface (482) for interaction with the filtering process shown and described in FIGS. 1-3. More specifically, the user interface (482) functions as a platform for a subject to review the key phrases, including the initial key phrases (492) and the secondary key phrase (494) maintained in the master list (490). In addition, the user interface (482) functions as a platform for document selection and filtering, creating the union of key phrases, and in one embodiment, selectively ranking the secondary key phrases (494) with respect to the initial key phrases (492). In one embodiment, the user interface (482) may be configured with a plurality of fields, including separate fields for each of the following: the population of the key phrases, the target corpus, and the domain corpus.

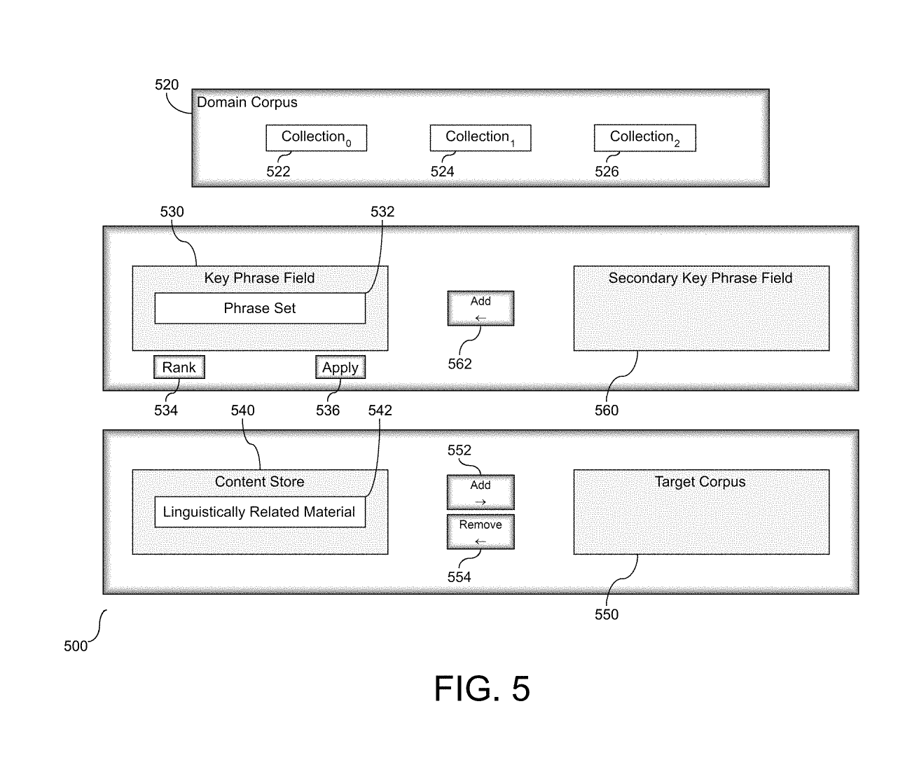

Referring to FIG. 5, a block diagram (500) is provided illustrating a user interface with a plurality of fields in support of populating and augmenting the target corpus. As shown, the domain corpus is shown as (520) with three collections (522), (524), and (526). Each of the collections in the domain corpus represents a collection of materials specific to a domain of interest. Examples of such domains include, but are not limited to finance, education, and healthcare. In one embodiment, the collections (522)-(526) may be expanded to include additional collections, and as such, the quantity of collections shown herein should not be considered limiting. A key phrase field (530) is shown populated with an initial set (532) of key phrases, which is related to the selected collection in the domain corpus. In this example, collection (522) is selected, and the initial set of key phrases (532), which is related to the selected collection, is populated into the field (530).

Each key phrase in the set (532) is a string or set of string characters that are related to the topic in the collection (522). In one embodiment, the phrases in the set (532) may be arranged in a ranked order. For example, a rank button (534) is shown, and selection of the button (534) support selection and movement of the key phrases in the list provided. In addition, an apply button (536) is provided in the field (530). In one embodiment, a single key phrase or multiple key phrases in the list may be selected, followed by selection of the apply button (536) to employ the selected key phrases to the content store (540) to search and parse the store for related or relevant materials in the collection. More specifically, one or more of the key phrases in the set (532) is applied to the content store (540) so search for material (542) to populate into a target corpus (550). The content store (540) represents article and publications, and application of a selection of the key phrases in the set (532) to the content store (540) facilitates extraction of material that is linguistically related to one or more of the application key phrases. Each linguistically related item is populated into the content store (540). A button (552) is located adjacent to both the content store (540) and the target corpus (550). In one embodiment, the user interface supports selectively adding items from the content store (540) to the target corpus (550) via the button (552). Similarly, as shown, the interface also provides an adjacently positioned remove button (554) to selectively remove one or more items from the target corpus (550).

Following an initial population of material into the content store, a secondary set of key phrases are identified and populated into a secondary key phrase field (560). In one embodiment, the secondary set may be an empty set, a single key phrase, or multiple key phrases. An add button (562) is shown adjacent to the field (560). The interface support selection of one or more of the secondary key phrases and adding the selection to the key phrase field (530). As secondary key phrases are selected and applied to the content store (540), new material may be identified for populating into the target corpus (550). Accordingly, as shown herein, the interface is an example of a platform in support of the system components and functionality as shown and described in FIG. 4.

The computing environment described above in FIG. 4 has been labeled with tools in the form of a target manager (430) and an extraction manager (440), hereinafter referred to as tools. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail to avoid obscuring aspects of the embodiments.

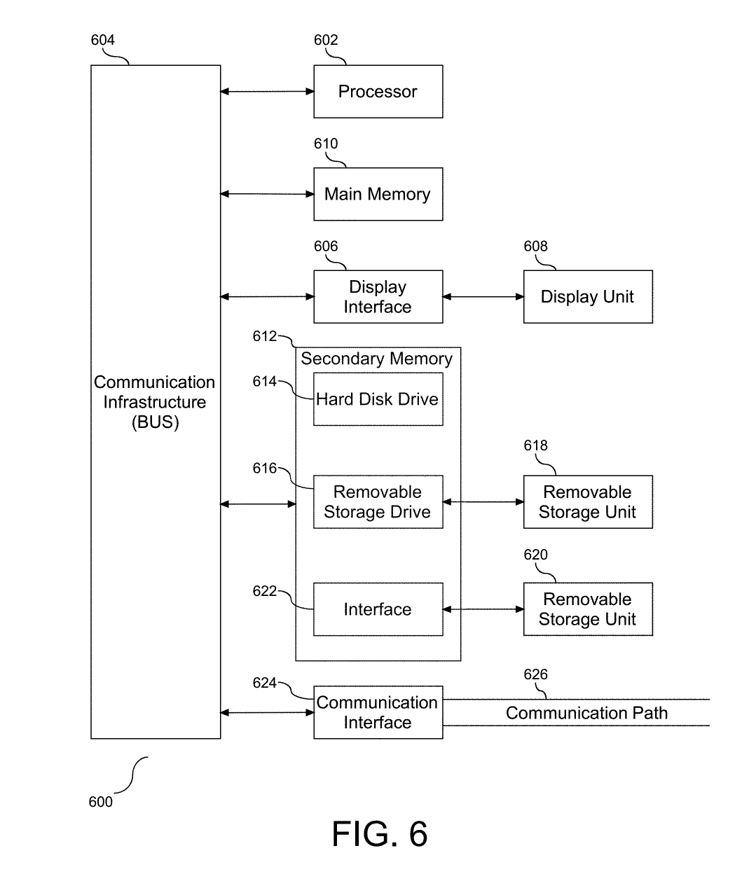

Referring now to the block diagram of FIG. 6, additional details are now described with respect to implementing one or more of the present embodiments. The computer system includes one or more processors, such as a processor (602). The processor (602) is connected to a communication infrastructure (604) (e.g., a communications bus, cross-over bar, or network).

The computer system can include a display interface (606) that forwards graphics, text, and other data from the communication infrastructure (604) (or from a frame buffer not shown) for display on a display unit (608). The computer system also includes a main memory (610), preferably random access memory (RAM), and may also include a secondary memory (612). The secondary memory (612) may include, for example, a hard disk drive (614) and/or a removable storage drive (616), representing, for example, a floppy disk drive, a magnetic tape drive, or an optical disk drive. The removable storage drive (616) reads from and/or writes to a removable storage unit (618) in a manner well known to those having ordinary skill in the art. Removable storage unit (618) represents, for example, a floppy disk, a compact disc, a magnetic tape, or an optical disk, etc., which is read by and written to by removable storage drive (616).

In alternative embodiments, the secondary memory (612) may include other similar means for allowing computer programs or other instructions to be loaded into the computer system. Such means may include, for example, a removable storage unit (620) and an interface (622). Examples of such means may include a program package and package interface (such as that found in video game devices), a removable memory chip (such as an EPROM, or PROM) and associated socket, and other removable storage units (620) and interfaces (622) which allow software and data to be transferred from the removable storage unit (620) to the computer system.

The computer system may also include a communications interface (624). Communications interface (624) allows software and data to be transferred between the computer system and external devices. Examples of communications interface (624) may include a modem, a network interface (such as an Ethernet card), a communications port, or a PCMCIA slot and card, etc. Software and data transferred via communications interface (624) is in the form of signals which may be, for example, electronic, electromagnetic, optical, or other signals capable of being received by communications interface (624). These signals are provided to communications interface (624) via a communications path (i.e., channel) (626). This communications path (626) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (610) and secondary memory (612), removable storage drive (616), and a hard disk installed in hard disk drive (614).

Computer programs (also called computer control logic) are stored in main memory (610) and/or secondary memory (612). Computer programs may also be received via a communication interface (624). Such computer programs, when run, enable the computer system to perform the features of the present embodiment(s) as discussed herein. In particular, the computer programs, when run, enable the processor (602) to perform the features of the computer system. Accordingly, such computer programs represent controllers of the computer system.

The present embodiment(s) may be a system, a method, and/or a computer program product. The computer program product may include a computer readable storage medium (or media) having computer readable program instructions thereon for causing a processor to carry out aspects of the present embodiment(s).

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present embodiment(s) may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present embodiment(s).

Aspects of the embodiments are described herein with reference to flowchart illustrations and/or block diagrams of methods, apparatus (systems), and computer program products according to the present embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to the various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As is known in the art, cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Example of such characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

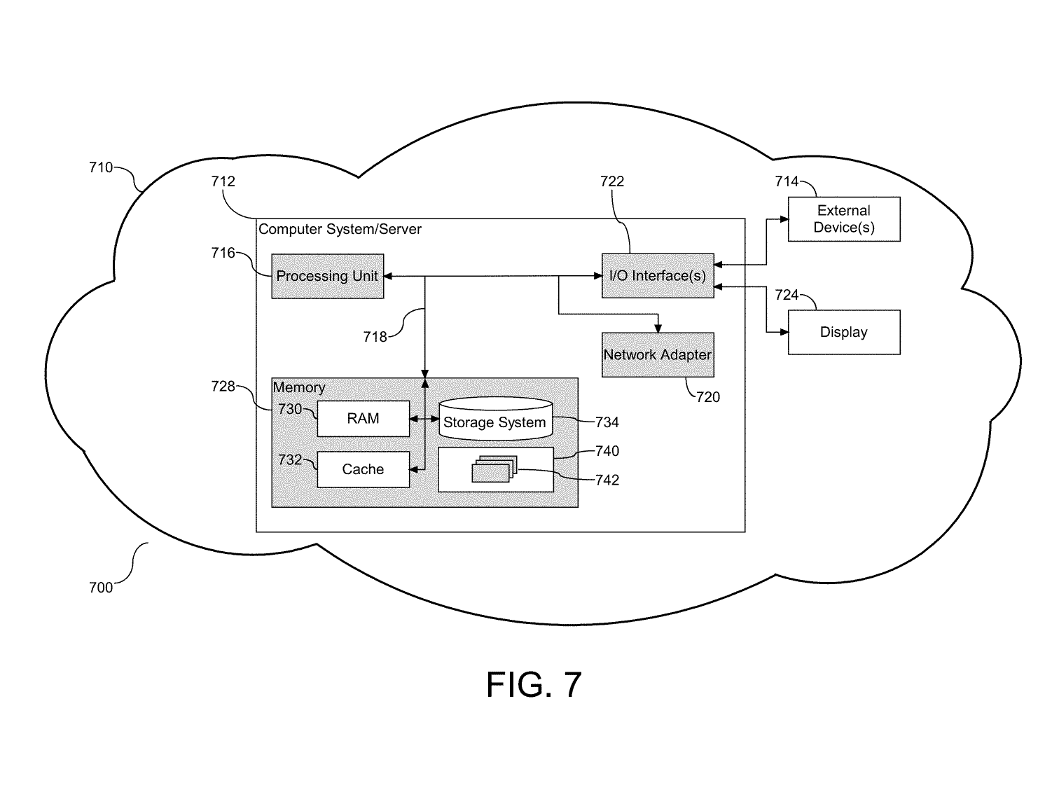

Referring now to FIG. 7, a schematic of an example of a cloud computing node (700) is shown. Cloud computing node (710) is only one example of a suitable cloud computing node and is not intended to suggest any limitation as to the scope of use or functionality of the embodiments described herein. Regardless, the cloud computing node is capable of being implemented and/or performing any of the functionality set forth hereinabove.

In cloud computing node (710) there is a computer system/server (712), which is operational with numerous other general purpose or special purpose computing system environments or configurations. Examples of well-known computing systems, environments, and/or configurations that may be suitable for use with computer system/server (712) include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server (712) may be described in the general context of computer system executable instructions, such as program modules, being executed by a computer system. Generally, program modules may include routines, programs, objects, components, logic, data structures, and so on that perform particular tasks or implement particular abstract data types. Computer system/server (712) may be practiced in distributed cloud computing environments where tasks are performed by remote processing devices that are linked through a communications network. In a distributed cloud computing environment, program modules may be located in both local and remote computer system storage media including memory storage devices.

As shown in FIG. 7, computer system/server (712) in cloud computing node (710) is shown in the form of a general-purpose computing device. The components of computer system/server (712) may include, but are not limited to, one or more processors or processing units (716), a system memory (728), and a bus (718) that couples various system components, including system memory (728) to processor (716).

Bus (718) represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server (712) typically includes a variety of computer system readable media. Such media may be any available media that is accessible by computer system/server (712), and it includes both volatile and non-volatile media, removable and non-removable media.

System memory (728) can include computer system readable media in the form of volatile memory, such as random access memory (RAM) (730) and/or cache memory (732). Computer system/server (712) may further include other removable/non-removable, volatile/non-volatile computer system storage media. By way of example only, storage system (734) can be provided for reading from and writing to a non-removable, non-volatile magnetic media (not shown and typically called a “hard drive”). Although not shown, a magnetic disk drive for reading from and writing to a removable, non-volatile magnetic disk (e.g. a “floppy disk”), and an optical disk drive for reading from or writing to a removable, non-volatile optical disk such as a CD-ROM, DVD-ROM or other optical media can be provided. In such instances, each can be connected to bus (718) by one or more data media interfaces. As will be further depicted and described below, memory (728) may include at least one program product having a set (e.g., at least one) of program modules that are configured to carry out the functions of embodiments.

Program/utility (740), having a set (at least one) of program modules (742), may be stored in memory (728) by way of example, and not limitation, as well as an operating system, one or more application programs, other program modules, and program data. Each of the operating system, one or more application programs, other program modules, and program data or some combination thereof, may include an implementation of a networking environment. Program modules (742) generally carry out the functions and/or methodologies of the embodiments as described herein.

Computer system/server (712) may also communicate with one or more external devices (714) such as a keyboard, a pointing device, a display (724), etc.; one or more devices that enable a user to interact with computer system/server (712); and/or any devices (e.g., network card, modem, etc.) that enable computer system/server (712) to communicate with one or more other computing devices. Such communication can occur via Input/Output (I/O) interfaces (722). Still yet, computer system/server (712) can communicate with one or more networks such as a local area network (LAN), a general wide area network (WAN), and/or a public network (e.g., the Internet) via network adapter (720). As depicted, network adapter (720) communicates with the other components of computer system/server (712) via bus (718). It should be understood that although not shown, other hardware and/or software components could be used in conjunction with computer system/server (712). Examples, include, but are not limited to: microcode, device drivers, redundant processing units, external disk drive arrays, RAID systems, tape drives, and data archival storage systems, etc.

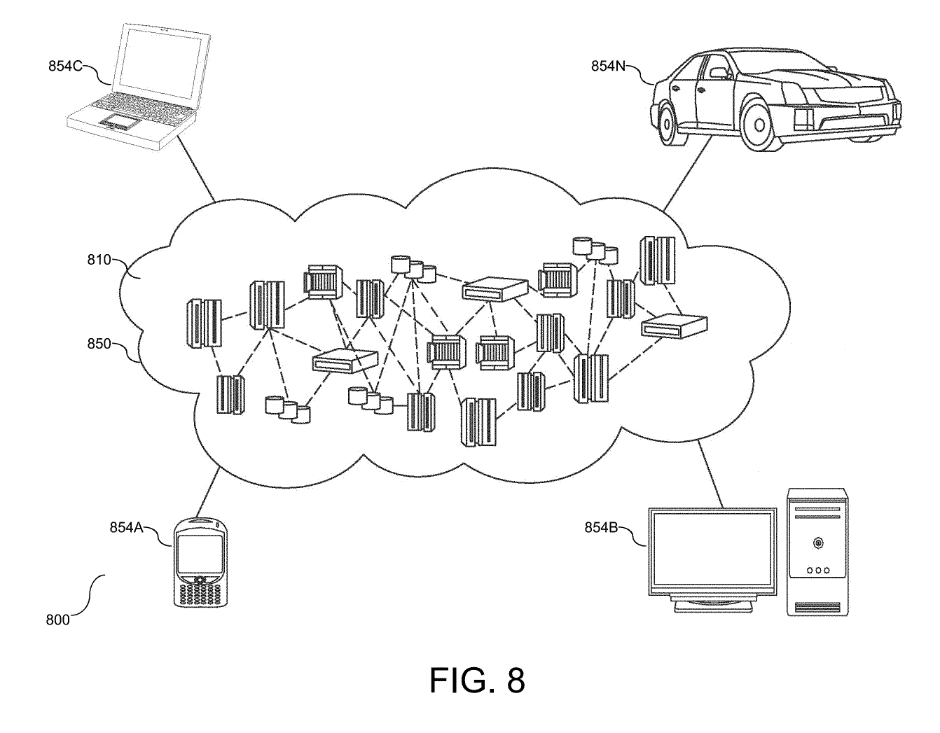

Referring now to FIG. 8, an illustrative cloud computing environment (800) is depicted. As shown, cloud computing environment (800) comprises one or more cloud computing nodes (810) with which local computing devices used by cloud consumers, such as, for example, personal digital assistant (PDA) or cellular telephone (854A), desktop computer (854B), laptop computer (854C), and/or automobile computer system (854N) may communicate. Nodes (810) may communicate with one another. They may be grouped (not shown) physically or virtually, in one or more networks, such as Private, Community, Public, or Hybrid clouds as described hereinabove, or a combination thereof. This allows cloud computing environment (800) to offer infrastructure, platforms and/or software as services for which a cloud consumer does not need to maintain resources on a local computing device. It is understood that the types of computing devices (854A)-(854N) shown in FIG. 8 are intended to be illustrative only and that computing nodes (810) and cloud computing environment (800) can communicate with any type of computerized device over any type of network and/or network addressable connection (e.g., using a web browser).

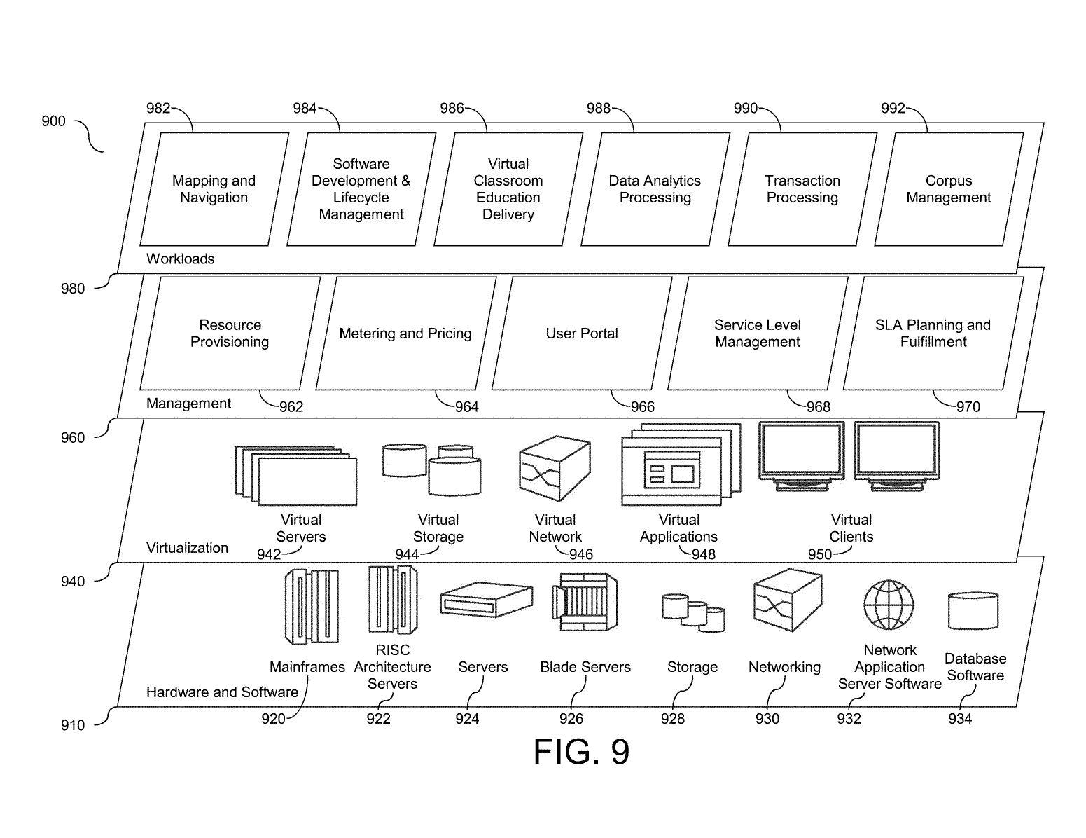

Referring now to FIG. 9 a set of functional abstraction layers (900) provided by cloud computing environment (700) of FIG. 7 is shown. It should be understood in advance that the components, layers, and functions shown in FIG. 9 are intended to be illustrative only and the embodiments are not limited thereto. As depicted, the following layers and corresponding functions are provided:

Hardware and software layer (910) includes hardware and software components. Examples of hardware components include mainframes (920); RISC (Reduced Instruction Set Computer) architecture based servers (922); servers (924); blade servers (926); storage devices (928); networks and networking components (930). In some embodiments, software components include network application server software (932) and database software (934).

Virtualization layer (940) provides an abstraction layer from which the following examples of virtual entities may be provided: virtual servers (942); virtual storage (944); virtual networks (946), including virtual private networks; virtual applications and operating systems (948); and virtual clients (950).

In one example, management layer (960) may provide the functions described below. Resource provisioning (962) provides dynamic procurement of computing resources and other resources that are utilized to perform tasks within the cloud computing environment. Metering and Pricing (964) provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal (966) provides access to the cloud computing environment for consumers and system administrators. Service level management (968) provides cloud computing resource allocation and management such that required service levels are met. Service Level Agreement (SLA) planning and fulfillment (970) provides pre-arrangement for, and procurement of, cloud computing resources for which a future requirement is anticipated in accordance with an SLA.

Workloads layer (980) provides examples of functionality for which the cloud computing environment may be utilized. Examples of workloads and functions which may be provided from this layer include: mapping and navigation (982); software development and lifecycle management (984); virtual classroom education delivery (986); data analytics processing (988), such as identification of linguistically related content; transaction processing (990); and corpus management (992).

As will be appreciated by one skilled in the art, the embodiments described herein may be embodied as a method, a system, or a computer program product. Accordingly, aspects of the embodiments may take the form of an entirely hardware embodiment, an entirely software embodiment (including firmware, resident software, micro-code, etc.) or an embodiment containing software and hardware aspects. Furthermore, aspects of the embodiments may take the form of a computer program product embodied in one or more computer readable medium(s) having computer readable program code embodied thereon.

The computer program product may include a computer readable storage medium (or media) having computer readable program instructions thereon for causing a processor to carry out aspects of the present embodiment(s). The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The corresponding structures, materials, acts, and equivalents of all means or step plus function elements in the claims below are intended to include any structure, material, or act for performing the function in combination with other claimed elements as specifically claimed. The description of the present embodiment(s) has been presented for purposes of illustration and description, but is not intended to be exhaustive or limited to the embodiment(s) in the form disclosed. Many modifications and variations will be apparent to those of ordinary skill in the art without departing from the scope and spirit of the embodiment(s). The embodiment was chosen and described in order to best explain the principles of the embodiment(s) and the practical application, and to enable others of ordinary skill in the art to understand the embodiments with various modifications as are suited to the particular use contemplated. Accordingly, the implementation of iteratively expanding a target corpus shown and described herein identifies linguistically related material and populates the identified material into the target corpus, thereby augmenting the aspect of populating the target corpus with pertinent content.

It will be appreciated that, although specific embodiments have been described herein for purposes of illustration, various modifications may be made without departing from the spirit and scope of the embodiments. In particular, the aspect of linguistically related content may be expanded to include content with a strong relation to the searched component(s). Accordingly, the scope of protection of this invention is limited only by the following claims and their equivalents.

1-6. (canceled)

7. A computer program product for automatically identifying linguistically related material within a computing environment, the computer program product comprising:
a computer readable storage device readable by a processing unit and having stored instructions for execution by the processing unit for performing a method comprising:
initializing a target corpus;
identifying one or more initial key phrases from a domain corpus related to the target corpus wherein each initial key phrase comprises string, the identification is based on a statistical analysis of the domain corpus:
extracting the identified initial key phrases,
storing the extracted initial key phrases in a master list at a first memory location;
employing an application to automatically expand the target corpus, the automatic expansion including:
selecting one or more documents from a source corpus stored at a second memory location;
selectively filtering the selected documents based on a value associated with each key phrase in the master list and a first linguistic relationship between each key phrase in the master list and the selected one or more documents;
populating the target corpus with the filtered documents;
identifying one or more new key phrases from the populated target corpus;
assigning a first value to the identified one or more new key phrases based on a second linguistic relationship to the target corpus; and
adding the identified new key phrases to the master list, and applying a union of the new key phrases to extract a second set of related documents for populating to the populated target corpus;
learning from the document filtering comprising:
identifying one or more secondary documents present in the filtered list and absent from the target corpus;
identifying one or more secondary key phrases associated with the secondary documents;
assigning a second value to the identified secondary key phrases based on a third linguistic relationship to the target domain; and
updating the master list for subsequent iterations, wherein the master list update discounts the second value assigned to at least one secondary key phrase; and
concluding the automatic expansion responsive to a criteria of the target corpus.

8. (canceled)

9. The computer program product of claim 7, wherein the second set of related documents populated to the target corpus is linguistically related to documents previously added to the target corpus.

10. The computer program product of claim 7, wherein the automatic expansion further comprises an iterative expansion of the target corpus for linguistically related documents.

11. The computer program product of claim 10, wherein the iterative expansion further comprises limiting the expansion of documents being added to the target corpus to new content within the second subset.

12. The computer program product of claim 10, further comprising identifying a threshold associated with the criteria and wherein concluding the automatic expansion includes the criteria meeting the threshold.

13. A computer system comprising:
a processing unit operatively coupled to memory;
a target manager in communication with the processing unit, the target manager to initialize a target corpus;
an extraction manager in communication with the target manager, the extraction manager to identify initial key phrases from a domain corpus related to the target corpus wherein each initial key phrase comprises string, the identification is based on a statistical analysis of the domain corpus;
the extraction manager to extract the identified initial key phrases, and store the identified initial key phrases in a master list at a first memory location;
the processing unit to support an application to automatically expand the target corpus, the application to:
select one or more documents from a source corpus stored at a second memory location;
selectively filter the selected documents for the potential inclusion based a value associated with each key phrase in the master list and a first linguistic relationship between the each key phrase in the master list and the selected one or more documents;
populate the target corpus with the filtered documents;
identify one or more new key phrases from the populated target corpus;
assign a first value to the identified one or more new key phrases based on a second linguistic relationship to the target corpus; and
add the identified new key phrases to the master list, and apply a union of the new key phrases and prior key phrases to extract a second set of related documents for population to the populated target corpus;
the target manager to learn from the document filter, including the target manager to:
identify one or more secondary documents present in the filtered list and absent from the target corpus;
identify one or more secondary key phrases associated with the secondary documents;
assign a second value to the identified secondary key phrases based on a third linguistic relationship to the target domain; and
update the master list for a subsequent iteration, wherein the master list update discounts the second value assigned to at least one secondary key phrase; and
the application to conclude the automatic expansion responsive to a criteria of the target corpus.

14. (canceled)

15. The system of claim 14, wherein the second set of related documents populated to the target corpus is linguistically related to documents previously added to the target corpus.

16. The system of claim 13, wherein the automatic expansion further comprises an iterative expansion of the target corpus for linguistically related documents.

17. The system of claim 16, further comprising the extraction manager to limit the expansion of documents being added to the target corpus to new content within the second subset.

18. The system of claim 16, further comprising the extraction manager to identify a threshold associated with the criteria and wherein conclude the automatic expansion includes the criteria to meet the threshold.

19. A computer program product for automatically identifying linguistically related material within a computing environment, the computer program product comprising:
a computer readable storage medium readable by a processing unit and having stored instructions for execution by the processing unit for performing a method comprising:
initializing a target corpus;
identifying initial key phrases from a domain corpus related to the target corpus wherein each initial key phrase comprises string, the identification is based on a statistical analysis of the domain corpus;
extracting the identified initial key phrases; and
storing the extracted initial key phrases in a master list at a first memory location;
ranking the master list;
identifying a target corpus criteria;
employing an application to automatically expand the target corpus, the automatic expansion including:
selectively populating the target corpus with one or more documents from a source corpus based on the ranking and a first linguistic relationship between each key phrase in the master list and the one or more documents; and
identifying one or more new key phrases from the selectively populated target corpus;
assigning a first value to the identified one or more new key phrases based on a second linguistic relationship to the target corpus; and
adding the identified new key phrases to the master list, and applying a union of the new key phrases to extract a second set of related documents for populating to the selectively populated target corpus;
learning from the selective population comprising:
identifying one or more secondary documents present in the filtered list and absent from the target corpus;
identifying one or more secondary key phrases associated with the secondary documents;
assigning a second value to the identified secondary key phrases based on a third linguistic relationship to the target domain; and
updating the master list for subsequent iterations, wherein the master list update discounts the second value assigned to at least one secondary key phrase; and
concluding the automatic expansion when the identified target corpus criteria meets a threshold.

20. (canceled)

21. The computer program product of claim 7, further comprising the application to output a platform to support a review action, the review action selected from the group consisting of: document selection, document filtering, and phrase unification.

22. The computer system of claim 13, further comprising the processing unit to support the to output a platform to support a review action, the review action selected from the group consisting of: document selection, document filtering, and phrase unification.

23. The computer program product of claim 19, further comprising the the application to output a platform to support a review action, the review action selected from the group consisting of: document selection, document filtering.

24. The computer program product of claim 7, further comprising ranking documents present in the target corpus based on the value assigned to each key phrase;
identifying one or more third key phrases from the target corpus based on the ranking;
adding the identified third key phrases to the master list; and
applying a union of the third key phrases to extract a third set of related documents for populating to the target corpus.

25. The computer program product of claim 12, wherein the criteria is selected from the group consisting of: a quantity of the new key phrases, a quantity of the filtered documents, and a size of the target corpus.

26. The computer program product of claim 7, wherein the statistical analysis further comprising determining the occurrence of the initial key phrases within the domain corpus.

27. The system of claim 13, further comprising the extraction manager to:
rank documents present in the target corpus based on the value assigned to each key phrase;
identify one or more third key phrases from the target corpus based on the ranking;
add the identified third key phrases to the master list; and
apply a union of the third key phrases to extract a third set of related documents for populating to the target corpus.

28. The system of claim 18, wherein the criteria is selected from the group consisting of: a quantity of the new key phrases, a quantity of the filtered documents, and a size of the target corpus.

29. The system of claim 13, wherein the statistical analysis further comprising the extraction manager to determine the occurrence of the initial key phrases within the domain corpus.
